(19) United States
(12) Patent Application Publication
(10) Pub. No.: US 2013/0242273 A1
(43) Pub. Date: Sep. 19, 2013

(54) LIGHTING APPARATUS FOR GENERATING LIGHT

(71) Applicants: Ulrich Weichmann, Eindhoven (NL); Uwe Mackens, Eindhoven (NL); Joachim Opitz, Eindhoven (NL)

(72) Inventors: Ulrich Weichmann, Eindhoven (NL); Uwe Mackens, Eindhoven (NL); Joachim Opitz, Eindhoven (NL)

(73) Assignee: KONINKLIJKE PHILIPS ELECTRONICS N.V., EINDHOVEN (NL)

(21) Appl. No.: 13/989,555

(22) PCT Filed: Dec. 2, 2011
(86) PCT No.: PCT/IB11/55426

§ 371 Date: May 24, 2013

(30) Foreign Application Priority Data
Dec. 9, 2010 (EP) 10194279.5

(51) Int. Cl. F21V 9/08; G03B 21/20

(52) U.S. Cl. CPC F21V 9/08; G03B 21/2006
USPC 353/84; 362/84

(57) ABSTRACT

The invention relates to a lighting apparatus for generating light. A primary light generator generates primary light (6), which is converted by a light converting material (8) into secondary light (3), wherein the primary light is directed to a primary surface (9) of the light converting material. An enclosure (10) comprising a transparent cover (7) hermetically encloses the light converting material, wherein the transparent cover is transparent to the primary light and located on the primary surface of the light converting material. The enclosure increases the photostability of the light converting material. This allows increasing the intensity of the primary light by, for example, increasing the power of the primary light and, thus,of the secondary light, and/or by focusing the primary light onto a smaller area on the primary surface, thereby allowing decreasing the optical Étendue of the secondary light, without damaging the light converting material.

### FIELD OF THE INVENTION

The invention relates to a lighting apparatus and a lighting method for generating light. The invention relates further to a light application apparatus and a light application method for applying light of a lighting apparatus, and to a manufacturing method for manufacturing the lighting apparatus.

### BACKGROUND OF THE INVENTION

US 2008/0149958 A1 discloses a lighting apparatus comprising a light-radiating semiconductor component having a radiation-emitting semiconductor body and a luminescence conversion element. The semiconductor body emits radiation in the ultraviolet, blue and/or green spectral region and the luminescence conversion element converts a portion of the radiation into radiation of a longer wavelength. The light-radiating semiconductor component can be used for producing a light-emitting diode which radiates polychromatic light, in particular white light, with only a single light-emitting semiconductor body. However, such a light-emitting diode has the disadvantage that the maximum intensity of the radiation directed to the luminescence conversion element is relatively small, thereby limiting the maximum intensity of the polychromatic light and leading to an Étendue of the polychromatic light being rather large. This decreases the quality of the polychromatic light.

### SUMMARY OF THE INVENTION

It is an object of the present invention to provide a lighting apparatus and a lighting method for generating light, wherein the quality of the generated light can be increased. It is a further object of the present invention to provide a light application apparatus for applying light of the lighting apparatus, a corresponding light application method and a manufacturing method for manufacturing the lighting apparatus.

In a first aspect of the present invention a lighting apparatus for generating light is presented, wherein the lighting apparatus comprises:
a primary light generator for generating primary light,
a light converting material for converting the primary light into secondary light, wherein the primary light generator and the light converting material are arranged for allowing the primary light to be directed to a primary surface of the light converting material,
an enclosure for hermetically enclosing the light converting material, wherein the enclosure comprises a transparent cover, which is transparent to the primary light and which is located on the primary surface of the light converting material.

Since the enclosure hermetically encloses the light converting material, wherein the enclosure comprises a transparent cover, which is transparent to the primary light and which is located on the primary surface of the light converting material, the photostability of the light converting material is increased. This allows increasing the intensity of the primary light by, for example, increasing the power of the primary light and, thus, increasing the power of the secondary light, and/or by focusing the primary light onto a smaller area on the primary surface of the light converting material, thereby allowing decreasing the optical Étendue of the secondary light, without damaging the light converting material. By decreasing the optical Étendue of the secondary light and/or increasing the power of the secondary light, the quality of the secondary light can be improved.

Preferentially, the enclosure and the light converting material form a closed package, wherein the cover is tightly located on the light converting material.

The primary light generator is preferentially a laser for generating laser light as the primary light. The laser is, for example, a laser diode. The laser can be adapted to emit laser light within a wavelength range of 380 to 500 nm. For example, the laser light can have a wavelength of 405 or 450 nm.

It is preferred that the transparent cover comprises a planar outer surface which is located on the primary surface of the light converting material. This further increases the photostability of the light converting material and, thus, the ability to emit secondary light having a decreased Étendue.

The transparent cover can comprise a curved outer surface, which is directed away from the light converting material, for influencing at least one of the primary light and the secondary light. This allows influencing at least one of the primary light and the secondary light without necessarily using an additional optical element. For example, the cover can be a plano-convex lens comprising a planar surface and a convex surface, wherein the planar surface can be located on and directed towards the light converting material and wherein the convex surface can be directed away from the light converting material for, for instance, improving the light collection.

The transparent cover can also be a plate having two parallel planar surfaces, wherein one of these surfaces is located on the primary surface of the light converting material and the other of these surfaces is directed away from the light converting material.

In a preferred embodiment, the cover comprises at least one of an anti-reflection coating for reducing a reflection of the primary light and a dielectric coating for filtering out a predefined spectral part of the secondary light. The anti-reflection coating can increase the efficiency of the lighting apparatus, and the dielectric coating can ensure that only a desired spectral part of the secondary light is emitted by the lighting apparatus.

It is further preferred that the cover comprises glass. In particular, the cover comprises a planar glass surface located on the primary surface of the light converting material. By using a cover comprising a planar glass surface located on the primary surface of the light converting material, the photostability of the light converting material can be further increased.

It is also preferred that the cover comprises a heat-dissipating material. For example, the cover can comprise diamond material or sapphire material.

It is further preferred that the light converting material comprises luminescent material, for example, a phosphor. In particular, the light converting material can comprise inorganic phosphor. The phosphor comprises preferentially at least one of BAM, LuAG, YAG, SSONE, BSONE, BSSNE, ECAS.

It is further preferred that the light converting material comprises a binding material for binding the luminescent material. The binding material is preferentially a silicone binder. By binding the luminescent material with the binding material the photostability of the light converting material can be further increased.

In an embodiment, the enclosure is formed by a recess, in which the light converting material is located and which is closed by the cover, wherein the recess is formed in a rotatable element. The rotatable element is, for example, a rotatable wheel or a rotatable disc. If the rotatable element is rotated, wherein the position of the primary light is fixed, several regions of the light converting material are periodically irradiated by the primary light. This allows further increasing the intensity of the primary light, in particular, further focusing the primary light, without damaging the light converting material. If the rotatable element is a rotatable wheel or a rotatable disc, the primary light can illuminate the rotatable wheel or rotatable disc in a way, which corresponds to an illumination of a CD within, for example, a CD player, wherein the rotatable wheel or rotatable disc is rotated, while the primary light remains in a fixed position.

It is also preferred that one or several recesses are formed in the rotatable element, in which several different light converting materials are located for converting the primary light into secondary light comprising light generated by conversion of the primary light by the different light converting materials. For example, the different light converting materials can generate secondary light having different colors. If the rotatable element is rotated such that the human eye cannot follow the variation of the different colors, the resulting secondary light is perceived as mixed secondary light having a single mixture color. If the rotatable element is moved slowly, the human eye perceives the variation in color.

In a further aspect of the present invention a light application apparatus for applying light of a lighting apparatus is presented, wherein the light application apparatus comprises:
a lighting apparatus as defined in claim 1 for generating secondary light,
a light application unit for applying the secondary light.

It is preferred that the light application apparatus is a light projector and the light application unit is a projection unit adapted for using the secondary light for projecting a projection element. A projection element is, for example, an image or a movie, which is projected onto, for instance, a screen, by using the secondary light generated by the lighting apparatus. The projection element can be provided by a display of the projection unit, wherein the display can be a LCD-projection display. The light application apparatus can also be another apparatus, which can apply the secondary light, like a spot lighting apparatus, a fiber lighting apparatus or an architectural lighting apparatus.

In a further aspect of the present invention a lighting method for generating light is presented, wherein the lighting method comprises:
generating primary light by a primary light generator,
converting the primary light into secondary light by a light converting material, wherein the primary light generator and the light converting material are arranged for allowing the primary light to be directed to a primary surface of the light converting material, wherein the light converting material is hermetically enclosed by an enclosure, which comprises a transparent cover, which is transparent to the primary light and which is located on the primary surface of the light converting material.

In a further aspect a light application method for applying light of a lighting apparatus is presented, wherein the light application method comprises:
generating secondary light by a lighting apparatus defined in claim 1,
applying the secondary light by a light application unit.

In a further embodiment of the present invention a manufacturing method for manufacturing a lighting apparatus is presented as defined in claim 1, wherein the manufacturing method comprises:
providing a primary light generator for generating primary light, a light converting material for converting the primary light into secondary light, and an enclosure comprising a transparent cover, which is transparent to the primary light,
hermetically enclosing the light converting material within the enclosure such that the transparent cover is located on a primary surface of the light converting material,
arranging the primary light generator and the light converting material for allowing the primary light to be directed to the primary surface of the light converting material.

It shall be understood that the lighting apparatus of claim 1, the light application apparatus of claim 11, the lighting method of claim 13, the light application method of claim 14 and the manufacturing method of claim 15 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of a light application apparatus for applying light of an embodiment of a lighting apparatus,

FIG. 2 shows schematically and exemplarily a top view on a rotatable wheel of the lighting apparatus,

FIG. 3 shows schematically and exemplarily a cross section through a part of the rotatable wheel,

FIG. 4 shows schematically and exemplarily a cross section of a transparent cover for covering light converting material of the lighting apparatus,

FIG. 5 shows schematically and exemplarily a cross section through a rotatable wheel of another embodiment of the lighting apparatus,

FIG. 6 shows schematically and exemplarily a top view on an embodiment of a rotatable wheel,

FIG. 7 shows schematically and exemplarily another embodiment of a light application apparatus for applying light of a lighting apparatus,

FIG. 8 shows a flowchart exemplarily illustrating an embodiment of a lighting method for generating light,

FIG. 9 shows a flowchart exemplarily illustrating an embodiment of a light application method for applying light of a lighting apparatus, and

FIG. 10 shows a flowchart exemplarily illustrating an embodiment of a manufacturing method for manufacturing a lighting apparatus.

### DETAILED DESCRIPTION OF EMBODIMENTS

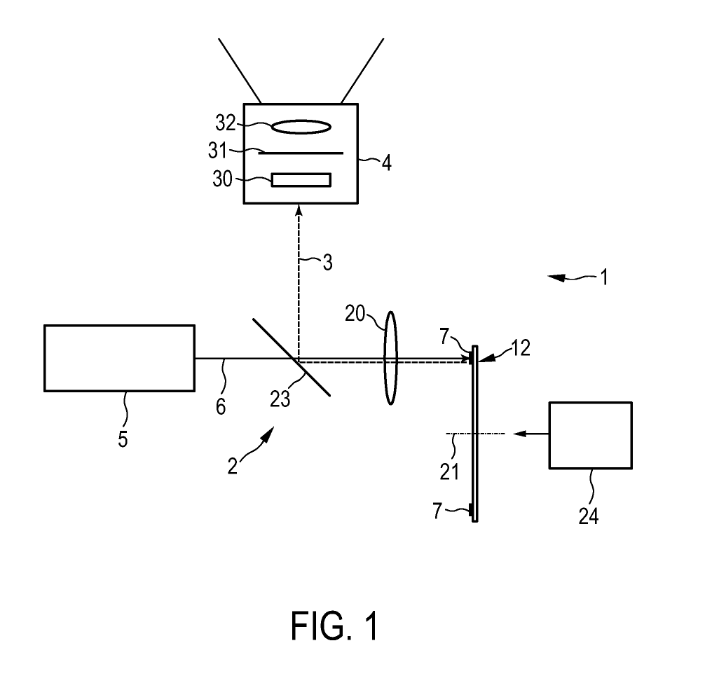

FIG. 1 shows schematically and exemplarily an embodiment of a light application apparatus 1 for applying light 3 of a lighting apparatus 2. In this embodiment, the light application apparatus 1 is a light projector comprising a light application unit 4 being a projection unit, wherein secondary light 3 is used for projecting a projection element (not shown in FIG. 1). A projection element is, for example, an image or a movie, which is projected onto, for instance, a screen, by using the secondary light 3 generated by the lighting apparatus 2. The projection element can be provided by a display 31 of the projection unit 4, wherein the secondary light is used for being projected through the display for projection the projection element onto, for example, a screen. The projection unit 4 can comprise optical elements 30 for ensuring that the display 31 is homogeneously illuminated by the secondary light 3 and a projection lens 32 for projecting the projection element onto, for example, the screen. Also other known projection units can be used for applying the secondary light. Moreover, the light application apparatus can also be another apparatus, which applies the secondary light 3 generated by the lighting apparatus 2, like a spot lighting apparatus, which is for example used in theaters to illuminate one specific actor, a fiber lighting apparatus, where the light is coupled into an optical fibre and sent via this fibre to another place, an architectural lighting apparatus that is used to illuminate houses, churches or other buildings, et cetera.

The lighting apparatus 2 comprises a primary light generator 5 for generating primary light 6, which traverses a beam splitter 23 and is focused by the lens 20 towards light converting material for converting the primary light 6 into secondary light 3.

The secondary light 3 generated by converting the primary light 6 is directed to the projection unit 4 via the lens 20 and the beam splitter 23. The projection unit 4 uses the secondary light 3, as already mentioned above, for projecting a projection element onto a screen. The light converting material is located within a rotatable element 12, which is rotatable around a rotational axis 21 by using, in this embodiment, a motor 24. Since the beam splitter 23 is transparent to the primary light, primary light, which may be reflected by, for example, the transparent cover 7, is not directed to the projection unit by the beam splitter 23.

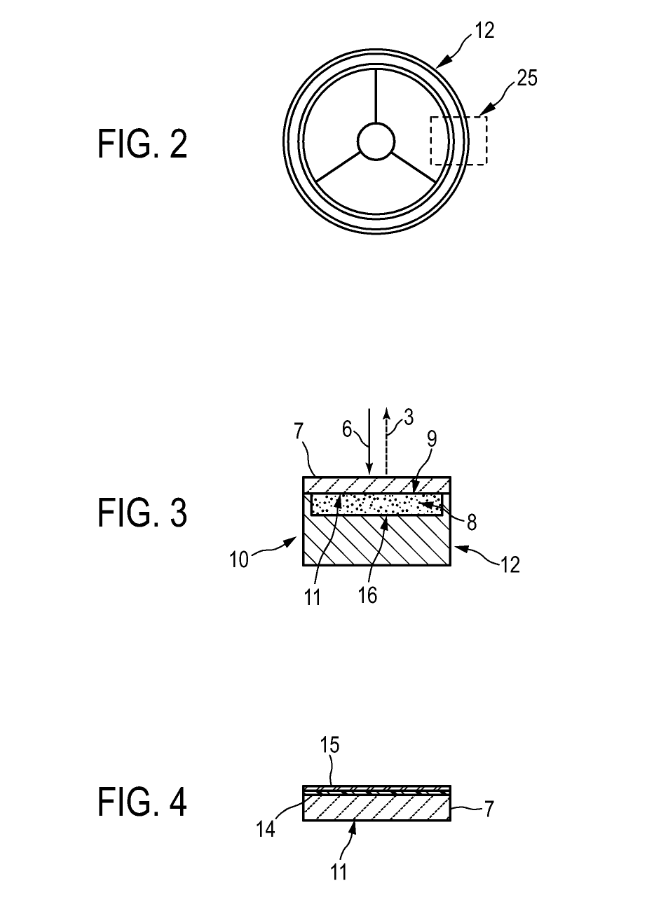

FIG. 2 shows schematically and exemplarily a top view on the wheel 21, and FIG. 3 shows schematically and exemplarily a cross sectional view through a region 25 of the wheel 12 indicated in FIG. 2 by the dashed box 25. As it can be seen in FIG. 3, the light converting material 8 is enclosed by an enclosure 10. The enclosure 10 is adapted to hermetically enclose the light converting material 8. The enclosure 10 comprises a transparent cover 7, which is transparent to the primary light 6 and which is located on a primary surface 9 of the light converting material 8. The primary light generator 5 and the light converting material 8 are arranged for allowing the primary light 6 to be directed to the primary surface 9 of the light converting material 8.

The enclosure 10 and the light converting material 8 form a closed package, wherein the cover 7 is tightly located on the primary surface 9 of the light converting material 8. In particular, the transparent cover 7 comprises a planar outer surface 11 which is located on the primary surface 9 of the light converting material 8. In this embodiment, the cover 7 is a glass plate, wherein the planar glass surface 11 is located on the primary surface 9 of the light converting material 8. In another embodiment, the cover can comprise, in particular, can be made of, a heat-dissipating material like a diamond material or sapphire material.

FIG. 4 shows the cover 7 in more detail. As can be schematically and exemplarily seen in FIG. 4, the cover 7 comprises an anti-reflection coating 15 for reducing a reflection of the primary light 6 and a dielectric coating 14 for filtering out a predefined spectral part of the secondary light 3. In other embodiments, the cover 7 may not comprise the anti-reflection coating 15 and/or the dielectric coating 14.

The primary light generator 5 is preferentially a laser for generating laser light as the primary light 6. The laser is, for example, a laser diode. The laser can be adapted to emit laser light within a wavelength range of, for example, 380 to 500 nm. In an embodiment, the laser light has a wavelength of 405 or 450 nm.

The light converting material 8 comprises phosphor, in particular, inorganic phosphor. Preferentially, the light converting material 8 comprises at least one of the following phosphor materials: BAM (BaMgAl₁₀O₁₇:Eu), LuAG (Lu₃Al₅O₁₂:Ce), YAG (Y₃Al₅O₁₂:Ce), SSONE (SrSi₂O₂N₂:Eu), BSONE (Ba₃Si₆O₁₂N₂:Eu), BSSNE ((Ba,Sr)₂Si₅N₈:Eu) and ECAS (CaSiAlN₃:Eu). The excitation wavelength for BAM is preferentially 405 nm for generating blue secondary light. For LuAG the excitation wavelength is preferentially 450 nm and the secondary light is preferentially green light. For YAG the excitation wavelength is preferentially 450 nm and the secondary light is preferentially yellow. For SSONE the excitation wavelength is preferentially 405 nm and/or 450 nm and the secondary light is preferentially green. Also for BSONE the excitation wavelength is preferentially 405 nm and/or 450 nm and the secondary light has preferentially a green color. For BSSNE the excitation wavelength is preferentially 405 nm and/or 450 nm and the secondary light has an orange color, and for ECAS the excitation wavelength is preferentially 405 nm and/or 450 nm and the secondary light has a red color. The primary light generator 5 is, in this embodiment, a laser, which is adapted such that primary light is emitted having at least the respective excitation wavelength.

For providing the light converting material phosphor powder is preferentially suspended into a 2-K silicone binder and homogenized with a high-speed mixer. Then, the suspension is dispensed in a recess 16 of the wheel 12. The recess 16 is preferentially a circular recess or a circular groove. The recess can help to realize a well-defined thickness of the layer of the light converting material 8. Then, the light converting material 8 is covered by the cover 7 that is pressed tightly against the suspension. The so-prepared wheel 12 is afterwards placed in an oven and heated to a temperature where the silicone solidifies by curing such that a closed package is obtained, in order to provide the enclosure 10 for enclosing the light converting material 8.

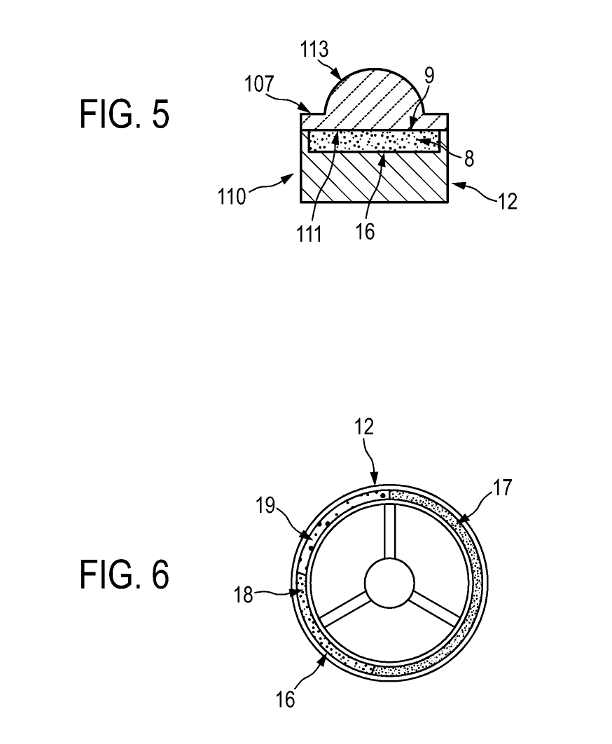

A further embodiment of an enclosure is schematically and exemplarily shown in FIG. 5. The enclosure 110 shown in FIG. 5 is also formed by a recess 16, in which the light converting material 8 is located and which is closed by a cover 107, wherein the recess 16 is formed in the wheel 12. The transparent cover 107 shown in FIG. 5 comprises a curved outer surface 113, which is directed away from the light converting material 8, for influencing at least one of the primary light and the secondary light. The transparent cover 107 comprises further a planar outer surface 111 which is located on the primary surface 9 of the light converting material 8. In this embodiment, the transparent cover 107 is a plano-convex lens comprising the planar surface 111 and the convex surface 113, wherein the planar surface 111 is located on and directed towards the light converting material 8 and wherein the convex surface 113 is directed away from the light converting material 8, in order to improve the light collection.

The wheel 12 can comprise one or several recesses 16, in which different light converting materials 17, 18, 19 can be located as schematically and exemplarily shown in FIG. 6, in order to convert the primary light 6 into secondary light comprising light generated by conversion of the primary light by the different light converting materials 17, 18, 19. The different light converting materials generate preferentially secondary light having different colors. If the wheel 12 is rotated such that the human eye cannot follow the radiation of the different colors, the resulting secondary light is perceived as mixed secondary light having a single mixture color. If the rotatable element is moved slowly, the human eye can perceive the variation in color. The different colors can be, for example, red, green and blue such that the lighting apparatus can be regarded as being an RGB light source.

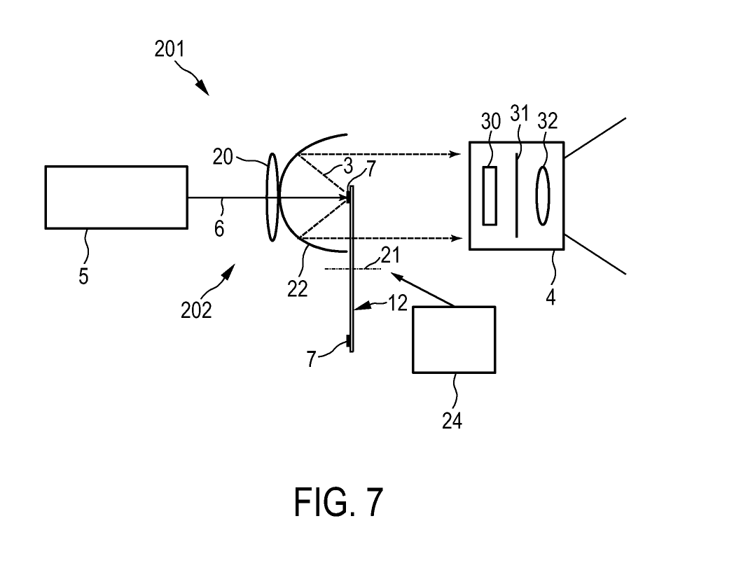

FIG. 7 shows schematically and exemplarily another embodiment of a light application apparatus 201 for applying secondary light 3 of a lighting apparatus 202. The lighting apparatus 202 comprises a wheel 12, which is rotatable around a rotational axis 21 and which comprises the light converting material 8. The wheel 12 is similar to the wheel described above with reference to FIGS. 1 to 3. Primary light 6 of a primary light generator 5 is focused by a lens 20 to the light converting material. The light converting material converts the primary light into the secondary light 3, which is collected and reflected by a reflector 22. The reflector 22 is preferentially formed by a part of inner sphere, wherein the inner surface of this part is reflective to the secondary light 3, for example, by providing an inner metallic surface. The reflector 22 comprises an opening for allowing the primary light 6 to meet the light converting material.

The reflector 22 is arranged such that the secondary light 3 is directed to a projection unit 4, which uses the secondary light 3 for projecting a projection element like an image or a movie, which may be provided on a display within the projection unit 4. The lighting apparatus 202 shown in FIG. 7 can also comprise the wheel described above with reference to FIG. 6, wherein different light converting materials can be used for generating secondary light having different colors. For example, red, green and blue secondary light can be generated by the different light converting materials, in order to provide an RGB light source. Alternatively, the wheel can comprise, for example, light converting materials for generating red and green secondary light, wherein a part of the wheel can be reflective to the primary light being, in this example, blue light, in order to provide an RGB light source. In a further example, the lighting apparatus can comprise an additional light source for emitting additional light. For example, the primary light generator can emit blue light, wherein a part of the blue light is directed on the light converting material for generating secondary light being green in this example. The additional light source can be adapted to emit red light. For instance, the additional light source can be a red emitting light emitting diode. In this case, the lighting apparatus can be regarded as being an RGB light source. Moreover, several wheels can be used, wherein each wheel comprises a light converting material generating secondary light having a certain color. Optical elements can be provided for combining the secondary light of the different wheels.

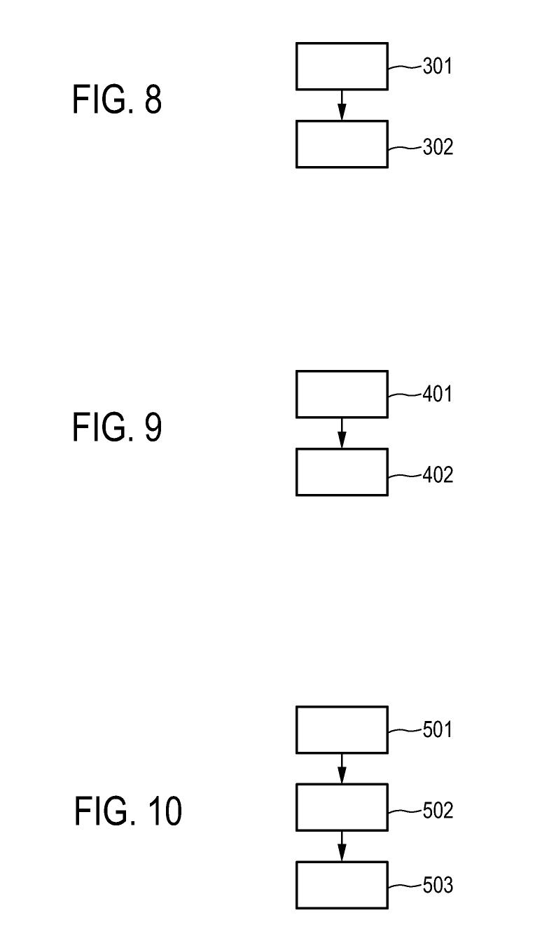

FIG. 8 shows a flowchart exemplarily illustrating a lighting method for generating light.

In step 301, primary light is generated by a primary light generator. In step 302, the primary light is converted into the secondary light by light converting material, wherein the primary light is directed to a primary surface of the light converting material, which is hermetically enclosed by an enclosure, which comprises a transparent cover, which is transparent to the primary light and which is located on the primary surface of the light converting material.

FIG. 9 shows a flowchart exemplarily illustrated an embodiment of a light application method for applying light of the lighting apparatus.

In step 401, secondary light is generated by the lighting apparatus as described above, for example, with reference to FIG. 8. In step 402, the secondary light is applied by a light application unit like a projection unit, for example, for projecting a projection element, for instance, a picture or a movie provided on a display, onto a screen.

FIG. 10 shows a flowchart exemplarily illustrating an embodiment of a manufacturing method for manufacturing the lighting apparatus. In step 501, a primary light generator for generating primary light, a light converting material for converting the primary light into secondary light, and an enclosure comprising a transparent cover, which is transparent to the primary light, are provided. The primary light generator is preferentially a laser, which is provided for manufacturing the lighting apparatus. The light converting material is preferentially provided by suspending phosphor powder into a 2-K silicone binder and by homogenizing the suspension with a high-speed mixer. The enclosure is preferentially provided by providing a rotatable element like the wheel 12 with a recess 16, which is preferentially a circular recess, and by further providing the transparent cover for enclosing the space formed by the recess 16. In step 502, the light converting material is hermetically enclosed within the enclosure such that the transparent cover is located on a primary surface of the light converting material. In particular, the suspension of the phosphor powder and the silicone binder is dispensed into the recess 16 and, the transparent cover 7 is tightly pressed against the suspension, while closing the space defined by the recess 16. The wheel is then preferentially placed in an oven and heated to a temperature where the silicone solidifies by curing, in order to obtain a closed package. In step 503, the primary light generator and the light converting material are arranged such that the primary light can be directed to the primary surface of the light converting material. In particular, optical elements can be provided for directing the primary light of the primary light generator to the light converting material.

The light application apparatus can be adapted for providing one or several applications using the secondary light, which preferentially require a small Étendue of the respective optical system. For example, the lighting application apparatus can be a digital projection apparatus, an optical fiber lighting apparatus, an architectural lighting apparatus, an entertainment lighting apparatus or a stage lighting apparatus. In these apparatuses, the primary light generator can be a high intensity gas discharge lamp like a UHP-lamp or a Xenon lamp. However, preferentially the primary light generator is a laser. Since the phosphor is enclosed in the enclosure, wherein preferentially a transparent glass cover with a plane surface is in contact with the primary surface of the light converting material, on which the primary light is directed, the photostability of the light converting material can be increased, thereby allowing the primary light to be more focused on the primary surface of the light converting material and, thus, allowing generating secondary light having a decreased Étendue. The secondary light can be collected very efficiently to illuminate, for example, DLP-, but also LCD- or even LCoS-displays.

Although in the above described embodiments, the lighting apparatus comprises a rotatable wheel, the lighting apparatus can also comprise a static support, on which the enclosed light converting material is provided, or another moveable element like a disc can be used instead of the rotatable wheel.

In an embodiment, the lighting apparatus can emit green secondary light, wherein a ring of green conversion material is used. Moreover, different segments, which may be made from different conversion materials as described above with reference to FIG. 6 and/or which may provide a reflection or diffuse reflection for the primary light, can be combined in order to realize light sources of mixed colors with different color properties.

Although above certain phosphor materials are described, the light converting material can also comprise other luminescent materials. Different luminescent materials can be used, depending on the wavelength of the primary light and the desired spectrum of the secondary light.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

The invention relates to a lighting apparatus for generating light. A primary light generator generates primary light, which is converted by a light converting material into secondary light, wherein the primary light is directed to a primary surface of the light converting material. An enclosure comprising a transparent cover hermetically encloses the light converting material, wherein the transparent cover is transparent to the primary light and located on the primary surface of the light converting material. The enclosure increases the photostability of the light converting material. This allows increasing the intensity of the primary light by, for example, increasing the power of the primary light and, thus, of the secondary light, and/or by focusing the primary light onto a smaller area on the primary surface, thereby allowing decreasing the optical Étendue of the secondary light, without damaging the light converting material.

1. A lighting apparatus for generating light, the lighting apparatus comprising:
a primary light generator for generating primary light,
a light converting material for converting the primary light into secondary light wherein the primary light generator and the light converting material are arranged for allowing the primary light to be directed to a primary surface-;; the light converting material,
an enclosure for hermetically enclosing the light converting material, wherein the enclosure comprises a transparent cover, which is transparent to the primary light and which is located on the primary surface is of the light converting material.

2. The lighting apparatus as defined in claim 1, wherein the transparent cover comprises a planar outer surface which is located on the primary surface of the light converting material.

3. The lighting apparatus as defined in claim 1, wherein the transparent cover comprises a curved outer surface, which is directed away from the light converting material, for influencing at least one of the primary light and the secondary light.

4. The lighting apparatus as defined in claim 1, wherein the cover comprises at least one of an anti-reflection coating for reducing a reflection of the primary light and a dielectric coating for filtering out a predefined spectral part of the secondary light.

5. The lighting apparatus as defined in claim 1, wherein the cover comprises glass.

6. The lighting apparatus as defined in claim 1, wherein the cover comprises a heat-dissipating material.

7. The lighting apparatus as defined in claim 1, wherein the light converting material comprises luminescent material.

8. The lighting apparatus as defined in claim 7, wherein the light converting material comprises a binding material for binding the luminescent material.

9. The lighting apparatus as defined in claim 1, wherein the enclosure is formed by a recess, in which the light converting material is located and which is closed by the cover, wherein the recess is formed in a rotatable element.

10. The lighting apparatus as defined in claim 9, wherein one or several recesses are formed in the rotatable element, in which several different light converting materials are located for converting the primary light into secondary light comprising light generated by conversion of the primary light by the different light converting materials.

11. A light application apparatus for applying light of a lighting apparatus, the light application apparatus comprising:
a lighting apparatus comprising a primary light generator for generating, primary light, a light converting material for converting the primary light into secondary light, wherein the primary light generator and the light converting material are arranged for allowing the primary light to be directed to a primary surface of the light converting material, an enclosure for hermetically enclosing the light converting material, wherein the enclosure comprises a transparent cover, which is transparent to the primary light and which is located on the primary surface of the light converting material,
a light application unit for applying the secondary light.

12. The lighting application apparatus as defined in claim 11, wherein the light application apparatus is a light projector, and the light application unit is a projection unit adapted for using the secondary light for projecting a projection element.

13. A lighting method for generating light, the lighting method comprising:
generating primary light by a primary light generator,
converting the primary light into secondary light by a light converting material, wherein the primary light generator and the light converting material are arranged for allowing the primary light to be directed to a primary surface of the light converting material, wherein the light converting material is hermetically enclosed by an enclosure, which comprises a transparent cover, which is transparent to the primary light and which is located on the primary surface of the light converting material.

14. (canceled)

15. A manufacturing method for manufacturing a lighting apparatus, the manufacturing method comprising:
providing a primary light generator for generating primary light, a light converting material for converting the primary light into secondary light, and an enclosure comprising a transparent cover, which is transparent to the primary light,
hermetically enclosing the light converting material within the enclosure such that the transparent cover is located on a primary surface of the light converting material,
arranging the primary light generator and the light converting material for allowing the primary light to be directed to the primary surface of the light converting material.
